(19) United States
(12) Patent Application Publication
(10) Pub. No.: US 2006/0013000 A1
(43) Pub. Date: Jan. 19, 2006

(54) Flat mount for light emitting diode source

(75) Inventors: Charles Coushaine, Rindge, NH (US); Michael Tucker, Henniker, NH (US); Thomas Tessnow, Weare, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/124,977

(22) Filed: May 9, 2005

Related U.S. Application Data
(60) Provisional application No. 60/588,627, filed on Jul. 16, 2004.

(51) Int. Cl. F21V 29/00

(52) U.S. Cl. 362/294

(57) ABSTRACT

A lamp assembly comprising: a side-emitting LED light source, a planar substrate having a first side and a second side, said LED light source being mounted in a center region of said first side, leaving an edge region of the first side extending circumferentially around said LED light source; said substrate having a portion of high thermal conductivity in thermal contact with said LED light source; a reflector having a reflective surface defining a concave cavity with an opening in a direction toward a field to be illuminated and having a through passage extending into said cavity; said LED light source being extended through said passage and having light emitting surfaces facing said reflective surface, said edge region being circumferentially sealed to said reflector, and electrical connections extending through said planar substrate connecting said LED light source to a supply of electrical power.

### CROSS-REFERENCE TO RELATED APPLICATIONS

This application claims priority from Provisional Patent Application No. 60/588,627, filed Jul. 16, 2004.

### TECHNICAL FIELD

This invention relates to electric lamps and particularly to electric lamps utilizing a single light emitting diode (hereafter LED or LEDs) light source. More particularly the invention is concerned with an electric lamp with an LED light source for providing a lamp assembly having a low profile.

### BACKGROUND ART

In the past, most automotive light sources have involved the use of incandescent bulbs. While working well and being inexpensive, these bulbs have a relatively short life and, of course, the thin filament employed was always subject to breakage due to vibration.

Recently some of the automotive uses, particularly the stoplight, have been replaced by LEDs. These solid-state light sources have incredible life times, in the area of 100,000 hours, and are not as subject to vibration failures. However, these LED sources have been hard-wired into their appropriate location, which increases the cost of installation. Additionally, the light sources have employed multiple LEDs, which increased the cost. It would therefore be an advance in the art if an LED light source could be provided that had the ease of installation of the incandescent light sources. Additionally, it would be advantageous to have a light source that could be permanently mounted without the need for any specific orientation. Still further, it would even more advantageous to have a lamp assembly utilizing a single LED, with said lamp assembly having a low profile.

### BRIEF SUMMARY OF THE INVENTION

It is, therefore, an object of the invention to obviate the disadvantages of the prior art. It is another object of the invention to enhance to provide a lamp assembly that is convenient and useful. Still another object of the invention is the provision of lamp assembly using a single LED and having a low profile. These objects are accomplished, in one aspect of the invention, by a lamp assembly comprising: an LED light source; a planar substrate having a first side and a second side, the LED being mounted in a center region of the first side, leaving an edge region of the first side extending circumferentially around the LED, the substrate having portions of high thermal conductivity in thermal contact with the LED; a reflector having a reflective surface defining a concave cavity open in a direction toward a field to be illuminated, the reflector being formed with a through passage extending to the cavity; the LED being extended through the passage to face the reflective surface, the edge region circumferentially sealed to the reflector, the substrate otherwise being mechanically coupled to the reflector; and electrical connections extending through the substrate connecting to the LED to supply electrical power to the LED. The use of the single LED centrally mounted upon a planar substrate with the substrate itself being mechanically coupled to the reflector allows for the provision of a lamp assembly having a low profile.

### BRIEF DESCRIPTION OF THE DRAWINGS

FIG. 1 is a diagrammatic view of an embodiment of the invention;

FIG. 2 is diagrammatic view of an alternate embodiment;

FIG. 3 is a diagrammatic view of yet another embodiment; and

FIG. 4 is a diagrammatic view of the size relationships of the elements of the lamp assembly

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

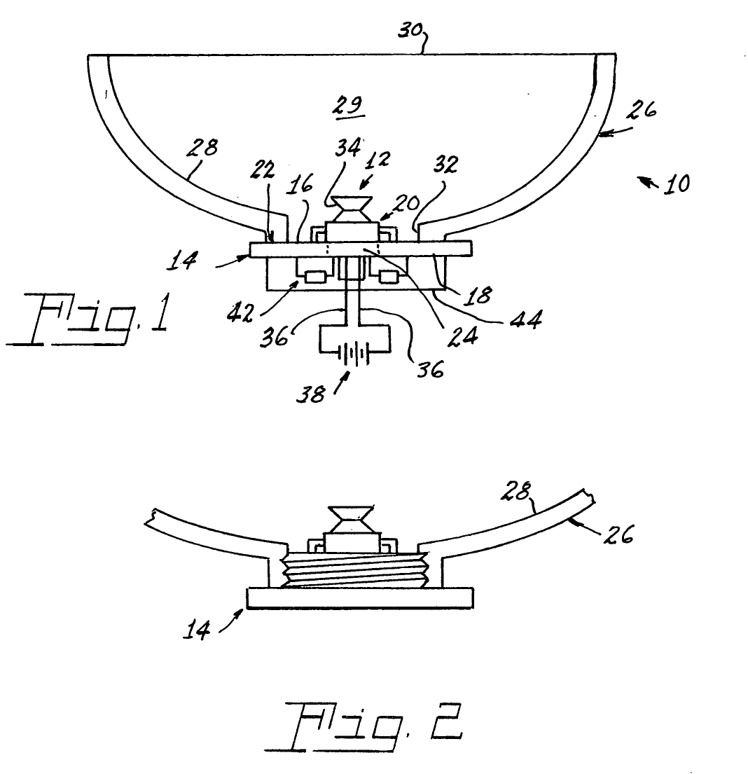

Referring now to the drawings with greater particularity, there is shown in FIG. 1 a lamp assembly 10 that comprises a side-emitting LED light source 12, mounted upon a planar substrate 14 that has a first side 16 and a second side 18. The LED light source 12 is mounted in a center region 20 of the first side 16, leaving an edge region 22 of the first side 16 extending circumferentially around the LED light source 12. The substrate 14 has at least a portion 24 of high thermal conductivity in thermal contact with the LED light source 12.

A reflector 26 has a reflective surface 28 defining a concave cavity 29 with an opening 30 in a direction toward a field to be illuminated and has a through passage 32 extending into the cavity 29. While not shown in the drawing, it will be apparent to those skilled in the art that any type of suitable covering, such as a lens, can be used to seal the opening 30.

The LED light source 12 extends through the passage 32 and has a light emitting surfaces 34 facing the reflective surface 28. The edge region 22 is circumferentially sealed to the reflector 26 in any of numerous ways, as will be detailed hereafter, and electrical connections 36 extend through the planar substrate 14 and connect the LED light source 12 to a supply of electrical power 38, which can be the battery or power source of a motor vehicle.

As mentioned above, the planar substrate 14 can be glued to the reflector 26 at the edge region 22 of the substrate. Alternatively, as shown in FIG. 2, the planar substrate 14 can be provided with a screw thread, as is known, and screwed into the reflector 26.

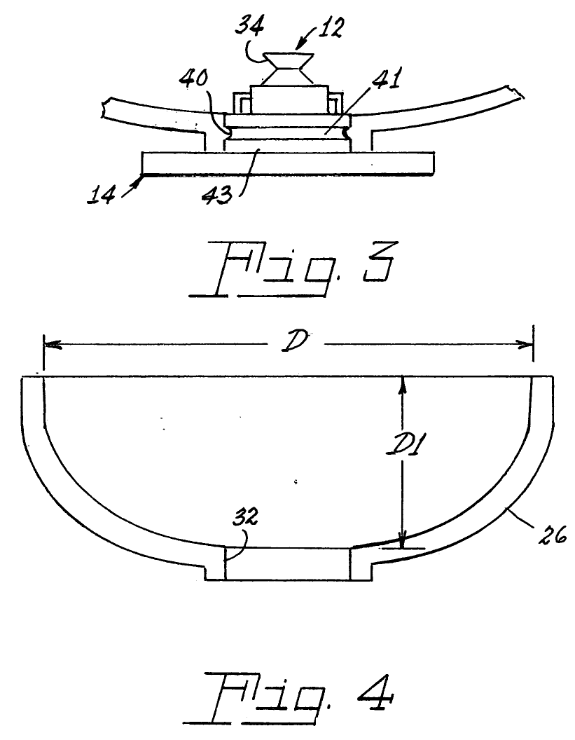

Another convenient structure can be a press-fit to a circumferential lip 40 formed on the reflector cooperating with a groove 41 formed on a boss 43 on the planar substrate 14 as shown in FIG. 3.

Preferably, the planar substrate 14 further supports a circuit 42 that provides controlled power to the LED source 12. In a preferred embodiment a cover 44 encloses the circuitry.

At least a portion 46 of the second side 18 of the planar substrate is exposed to the exterior of the lamp assembly 10 for heat dissipation from the planar substrate 14 and, if necessary because of the power requirements of the LED, additional heat sinking can be provided in that area.

To utilize the capabilities of the single LED, the reflector 26, as shown in FIG. 4, is shallow, having an internal face diameter D at least two times as large as the axial depth D1 from the front opening 30 to an interior passage plane 48.

Thus there is provided a lamp assembly that avoids the problems of the prior art. It is convenient to use and uses little depth, a decided advantage in automotive applications where space is always at a premium.

While there have been shown and described what are present considered to be the preferred embodiments of the invention, it will be apparent to those skilled in the art that various changes and modifications can be made herein without departing from the scope of the invention as defined by the appended claims.

What is claimed is:

1. A lamp assembly comprising:
an LED light source,
a planar substrate having a first side and a second side, the LED being mounted in a center region of the first side, leaving an edge region of the first side extending circumferentially around the LED; the substrate having portions of high thermal conductivity in thermal contact with the LED;
a reflector having a reflective surface defining a concave cavity open in a direction toward a field to be illuminated, the reflector being formed with a through passage extending to the cavity;
the LED being extended through the passage to face the reflective surface, the edge region circumferentially sealed to the reflector, the substrate otherwise being mechanically coupled to the reflector; and
electrical connections extending through the substrate connecting to the LED to supply electrical power to the LED.

2. The lamp assembly in claim 1, wherein the substrate is glued to the reflector.

3. The lamp assembly in claim 1, wherein the substrate is screwed to the reflector.

4. The lamp assembly in claim 1, wherein the substrate is press fit to a circumferential lip formed on the reflector.

5. The lamp assembly in claim 1, wherein the substrate further supports a circuit providing controlled power to the LED.

6. The lamp assembly in claim 1, further including an electrical socket for receiving electric power for the LED.

7. The lamp assembly in claim 1, further including a cover enclosing the circuit.

8. The lamp assembly in claim 1, wherein at least a portion of the second side of the substrate is exposed to the exterior for heat dissipation from the substrate.

9. The lamp assembly in claim 1, wherein at least a portion of the second side of the substrate is in thermal contact with a heat conductor exposed to the exterior for heat dissipation from the substrate.

10. The lamp assembly in claim 1, wherein the reflector is shallow, having an internal face diameter at least two times as large as the axial depth from the front face plane to the interior passage plane.

11. The lamp assembly in claim 1, wherein the LED is supported on a short axial support having an axial extension less than one fifth of the axial depth from the front face plane to the interior passage plane.
